(19) United States
(12) Patent Application Publication
(10) Pub. No.: US 2009/0248737 A1
(43) Pub. Date: Oct. 1, 2009

(54) COMPUTING ENVIRONMENT REPRESENTATION

(75) Inventors: Dharma Shukla, Sammamish, WA (US); Ori Amiga, Seattle, WA (US); Vij Vasu, Hyderabad (IN); Junfeng Zhang, Albany, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/057,000

(22) Filed: Mar. 27, 2008

(51) Int. Cl. G06F 17/30

(52) U.S. Cl. 707/103 R; 707/E17.055

(57) ABSTRACT

A computing environment typically comprises a large set of diverse objects, such as files, user profiles, executable binaries, configuration information, and data caches, wherein such objects are typically stored and managed by an aggregation of systems, such as a file system, a system registry, and an assembly cache. An alternative representation of the computer system may comprise an object hierarchy configured to store all of the objects of the computing environment according to a simple organizational grammar. Various services (e.g., a synchronization service, a backup service, and a sharing service) may be provided to manage the diverse objects in a similar manner. The representation may also be provided to a variety of devices, which may render the computing environment in a consistent manner but adjusted to reflect the capabilities of the device and the user. The computing environment is thereby represented in a deployable, consistent, and extensible manner.

### BACKGROUND

Modern computer systems comprise a large variety of interrelated objects, such as files and file collections (e.g., a set of MP3s comprising an album), applications, user profiles, personal data sets (e.g., bookmark lists, contact lists, and calendars), data caches (e.g., browser history and “most recently used” lists), password and permission sets (e.g., public/private key pairs, certificates, and data sharing information), and configuration information for the system, devices, operating shell, and applications. From another perspective, the computer system comprises a set of applications, each of which manages a complex data set comprising a distinct variety of data objects stored in various ways and locations of the computer system.

In many computer systems, these forms of data are arranged in an ad hoc manner, wherein some forms of data overlap in a functional but arbitrary manner (e.g., configuration information may be stored in one or more files, and files may be affected by data sharing permissions stored in a system registry.) Moreover, various computer systems may be configured to interoperate by sharing these objects in various ways, e.g., by synchronizing two sets of similar data across two or more devices.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The variety and interrelations of objects comprising a computer system may complicate many common operations. As a first example, an object backup, copy, or synchronization operation applied to a particular object set may be complicated by the representation of objects in many forms (such as files, configuration information stored in a system registry, user profile information, and protected password information) and in many locations, some of which may commingle objects of other object sets. As a second example, querying the computer system for a particular kind of object (e.g., all object owned by a particular user) may involve an extensive search of many object stores, such as file systems, registries, data caches, security privilege sets, and schema-specific portions of objects, such as records in a shared address list. As a third example, sharing an object set with another device (even if owned by the same user) may be complicated by the circumstances of network communication (e.g., where is the device located, and how much bandwidth can be utilized in communicating with it?) and the nature of the device (e.g., how much capacity does the target device have, and what sorts of objects can be sent to it, and how should it be formatted?) As a fourth example, the foregoing considerations may be further complicated in a scenario of sharing data among users, which may involve considerations of the roles and security privileges of the users. These problems and others may arise upon attempting to provide a consistent computing environment across multiple devices, including the same application set (albeit customized for the capabilities of each device)—especially where the object set is distributed across multiple devices, which ideally may operate seamlessly and be presented to the user as an aggregated object set.

In view of these considerations, a computer system may be devised that stores objects in a consistent manner and centralizes the management of objects for improved consistency and easier administration. A computer system may be devised as a primary access point comprising an aggregated object system that stores many types of objects—files and file sets, installed applications, various types of configuration information sets, user profiles and privileges, data caches, etc.—as one set of objects having some basic commonalities, and arranged in a hierarchy comprising the entire configuration of the computer system. The computer system may therefore perform operations such as querying, synchronizing, and copying in a uniform manner across all object types. The computer system may also manage a variety of devices exposing the same object set, such as by configuring the devices to present to the user consistent user interface and a common set of deployed applications. Moreover, the computer system may adjust the object set deployed to a device based on its capabilities, e.g., by deploying a full-featured version of an application to a more powerful device and a lighter version of the same application to a less powerful device. The computer system may also coordinate the synchronization of data distributed across the devices (e.g., by mapping some objects stored on a first device within the aggregated object system, such that when a second device attempts to access the aggregated object system, the computer system may automate and manage the exposure of the objects on the first device to the second device.) These and other aspects of this object system model promote a unification of the user experience across many devices, wherein, each device serves as a portal to the same object set, despite the myriad types and locations of the objects and the technicalities in exchanging and synchronizing such devices and objects.

Accordingly, an object system may be devised that represents all objects comprising a computer system in a single hierarchy and according to a common grammar. A computer system configured to manage objects stored in this manner may also comprise a set of services for performing various operations on the object set, such as backup, copying, synchronization, querying, sharing, security, concurrent access management, and rendering in various formats. Moreover, various portions of the object set may be extended with domain-specific data represented according to a common grammar, and may be managed by the services of the managing computer system in a consistent manner. The object set may also be rendered differently for different devices, thereby providing access to the same object set while also customizing the participation of a device based on its capabilities. A computer system modeled in this manner is therefore presented to the user in a consistent manner, and with improved automation of data exchange, object set synchronization, and device configuration.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary object hierarchy representing a computing environment.

FIG. 2 is an illustration of an exemplary grammar whereby objects comprising an object hierarchy representing a computing environment may be represented.

FIG. 3 is a flow diagram illustrating an exemplary method of representing a computing environment.

FIG. 4 is a component block diagram illustrating an exemplary system for representing a computing environment.

FIG. 5 is an illustration of some exemplary expansions of unexpanded nodes of an exemplary object hierarchy.

FIG. 6 is an illustration of some exemplary transformations of an exemplary object hierarchy according to various data interchange formats.

FIG. 7 is a component block diagram illustrating another exemplary system for representing a computing environment.

FIG. 8 is an illustration of an exemplary interaction of a computing environment host with various computing environment rendering devices.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Modern computer systems comprise a large number and variety of objects. Many computer systems feature a file store containing both the files for configuring the computer system (including executables, class libraries, configuration information sets, and resources) and user files generated or received by one or more users. Many computer systems also comprise a wide range of configuration information comprising the computer system hardware and software, including the hardware and devices of the computer system, the operating system, the shell user interface, and the configuration of the applications available within the shell user interface. Various user profiles and accounts may also exist, the former comprising information describing a particular user or user class (name, shell user interface preferences, home directory, etc.), and the latter comprising information describing the privileges of the user or class (file ownership, read/write privileges, access to various devices, etc.) Protected security information, such as passwords, certificates, public/private key pairs, and access control lists, may be stored in a security object, over which the operating system may exert regulated access. One or more data caches may exist, such as browser caches and histories, recent entries in application or browser textboxes, and recently used file and object lists. Various applications may create application- or task-specific archives, such as an email archive containing various folders and messages and a shared address book containing contact information received from various sources by various system users and organized in user-defined groups. Finally, the computer system may be configured to exchange particular sets of information with other computers, users, and devices, such as objects to be synchronized and object sets to which access may be granted with various conditions (read/write privileges, ownership, quotas, etc.) Such object types are typically managed by various management systems (e.g., a file system, a system registry store, a user account management system, and an email system) within the computer system in an ad hoc manner, with little consistency or standardization of access methods or object organization.

This large number and variety of objects comprising a computer system creates many problems in the use and administration of the computer system. As a first example, a backup operation of such a computer system may be very difficult, as it involves differentiating user data from system-specific information. This differentiation may not be simple; for instance, application configuration data may have been created by the user (who may desire to preserve the configuration) or by the application installer, and information about object ownership (which the user may wish to preserve) may be defined in terms of user profiles and accounts modeled by the computer system. As a second example, a user may wish to query the computer system for objects matching a certain description, such as objects that have been created or changed in the last seven days, but processing this query may involve many object stores (e.g., one or more file stores on various storage devices, the system registry, the browser cache and history, bookmarks stored in a browser bookmark set, and email messages managed by an email system.) These object stores may be managed as data silos, each managed by a different system with a particular (and often proprietary) interface, and with little commonality among the objects. As a third example, the object set of the computer system may be distributed across several devices, but providing consistent access to the object sets may be complicated by the various configurations of the devices, the network capabilities of each device, and incompatibilities in the wire formats used by each device for exchanging data (e.g., a first device may be configured to exchange data according to an XML schema, and a second device may be configured to exchange data according to JSON.)

A more detailed scenario in which the difficulties of an ad hoc arrangement of computer system objects relates to the presentation of a computer system in a device-independent manner. For example, a user may wish to access a host computer system on many types of devices, such as through a cellphone, through a second computer system (such as a notebook computer owned by the same user), and through a browser on a third computer system (such as a public access terminal.) The user may wish to access the same object store presented by of the host computer system, utilize the same applications that are installed and available on the host computer system, and experience the same user interface as configured on the host computer system.

The ad hoc arrangement of objects in the host computer system creates many difficulties in this scenario. First, the cellphone device may have very few computing resources, such as processing power and system memory, and may be able to store only a small portion of the object set comprising the computer system. Moreover, the cellphone device may be incapable of running the powerful applications installed on the host computer system, and the user may have to manually install cellphone-targeted versions of the same applications. Second, the notebook computer may only have sporadic network communication with the host computer system. The user may expect the notebook computer to mirror the host computer system, such as by installing the same applications and synchronizing changes to the object set between the computer systems. However, the storage of objects of many types and in many locations through many object systems may complicate the synchronization process, and the user may achieve only a partial mirroring of the computer system across both machines and with a significant amount of conscious effort (e.g., user-driven synchronization of files between the two machines.) The user may also have to install and configure the operating system and applications of the notebook computer separately from the host computer system, resulting in a duplication of administrative labor and likely computer system inconsistencies in the event of configuration differences. Third, the browser of the third computer system may be incapable of operating on the objects of the host computer system, and may be incapable of executing the applications installed on the host computer system.

One approach to providing a consistent user experience involves the configuration of devices as a thin client, wherein the host computer system sends the output of the user interface (including the display and sound output) to a device, and the device sends user input (including keyboard and pointing input) back to the host computer system. While a thin client approach may improve the consistency of the user interface exposed through multiple devices, this approach presents several drawbacks. First, the experience is often limited by the network capacity; e.g., playing a movie through a thin client interface may involve attempting to stream the movie with realtime performance across the network, which may not be feasible. This difficulty is caused by the local unavailability of the movie on the thin client device, which is merely a visual portal to the graphic interface of the host computer system. Second, the network latency of every user interaction diminishes the computing experience. Each time the user wishes to access an object—even accessing the same object repeatedly—the thin client device communicates the request to the host computer system for a response. Indeed, many thin clients are configured such that every keystroke is sent from the thin client device to the host computer system, received, and processed before the visual result of the keystroke is available to the device and displayed for the user. The network latency causes a lag in object access and user input realization that rapidly degrades the performance of the thin client user experience. Third, the user experience may be difficult to customize based on the resources of the thin client device. For example, a cellphone with limited screen resolution may be unable to display the native, large desktop space of the host computer system. Moreover, the host computer system may be unaware of the limitations of the thin client device (indeed, the host computer system may strive to render the same user interface and applications on the device in the interest of user experience consistency), and may be unable to configure an application for suitable performance on the thin client device (e.g., by configuring a web browser running on the host computer system to render pages in a mobile-friendly manner, such as the Wireless Application Protocol.) Fourth, this approach is difficult or untenable over an unavailable or sporadic network connection. The user may be unwilling to accept intermittent access to the host computer system, particularly if the thin client computer system has equivalent system resources (such as a notebook computer of similar capabilities as the host computer system) and may be capable of providing the same user experience if configured similarly to the host computer system and if a mirror copy of the object set is locally stored.

A second approach to providing a consistent user interface involves a roaming profile, comprising a transmission of user settings to several similarly configured devices that improves the presentation of a customized user interface. A device that connects to the roaming profile server may therefore receive the user profile and (e.g.) apply the custom configurations atop a default system configuration. While a roaming profile may be helpful for improving the deployment of a customized user interface across many devices, several drawbacks exist that limit the utility of a roaming profile approach for consistent ser interface access. First, the roaming profile is typically limited to the system configuration (e.g., application and shell settings) and user information (e.g., the user's name and security privileges), and is not structured to include objects, such as hierarchically organized files, application binaries, and security tokens. Second, because the roaming profile is specified as a set of configuration parameters to be applied atop the native configuration of the device, this approach is only feasible for devices configured in a similar manner. A high-performance workstation, a subnotebook device, and a cellphone are generally configured very differently, and a roaming profile targeted to one such device may be of limited use on the other devices, and might cause additional problems due to misconfiguration. For instance, a particular user preference (e.g., the time threshold between pointing-device clicks that signifies a double-click) might vary among different devices, but a roaming profile may undesirably apply one user preference to all such devices in order to promote a unified user experience. Moreover, a roaming profile configured for a workstation might reflect the user's preference for a Dvorak keyboard configuration, but applying the configuration information contained therein to a cellphone might result in a rearrangement of text input in an unusable manner. Third, roaming profiles are deployed through a read-only mechanism, and are not designed to accept the many changes to the computer environment that typically occur during a computing session. Fourth, at most, roaming profiles may achieve only a loose aggregation of the devices and data stored therein, and it may be difficult to specify particular aspects of device interrelationships (e.g., that a data store of a cellphone should be backed up to a network on a daily basis.) Thus, while roaming profiles may promote the configuration of several similar devices in a more uniform manner, this approach does not provide a unified user experience among a variety of interconnected devices.

In contrast with these approaches, the approach provided herein involves representing a computing environment in a manner that may be delivered to devices for rendering according to the capabilities of the device. The representation comprises a set of objects organized according to an object hierarchy and represented according to a common grammar. The objects include the data objects of the computer system, such as the user files and data created by the user. The objects also include the executable binaries and class libraries comprising the operating system components, such as the shell, and the applications offered therein. The object also include the information specifying the user interface of a computing environment, including shell preferences (e.g., visual themes, application launch menu, and double-click threshold), user accounts and privileges, security information (e.g., passwords, security tokens, and certificates), application binaries and configuration information, user data and metadata (e.g., file sharing information), and data caches (e.g., most-recently-used file lists and browser history.) Despite the various nature and uses of these objects, the objects are represented in a common manner in the object hierarchy, and may be arbitrarily organized in the hierarchy. Thus, in contrast with former systems comprising a set of isolated data stores, each containing one type of object (e.g., a file system containing files, a registry containing configuration information, and a data cache containing the browser history), the object hierarchy in this approach organizes all such objects in a common manner in the object hierarchy.

A computing environment represented in this manner may be delivered to any device and rendered in a manner suitable for the capabilities of the device. For instance, a primary workstation may render the information as a robust and general-purpose computing environment, while a public workstation may render a different computing environment experience through a web browser (e.g., as a virtual machine that may be discarded at the end of the user's session), and a cellphone may provide a leaner interface with quicker access to cellphone-related information (e.g., contacts, calendar, and navigation data.) Moreover, updates to the information set (e.g., preference changes and updates to data files contained therein) may be applied to the primary source of the information set, and thereby propagated to all other devices to which the information set is delivered. Also, the devices sharing the computing environment may be integrated through the shared information set, such that one device may interact with others that are identified in the information set; e.g., data stored on a first device may be accessed by a second device, and a first device may be controlled by a second device through a communications conduit. The information set may therefore identify the collection of devices that share the computing environment, along with the roles, capabilities, and resources of each device, to provide an integrated computing experience across a potentially large number and variety of devices.

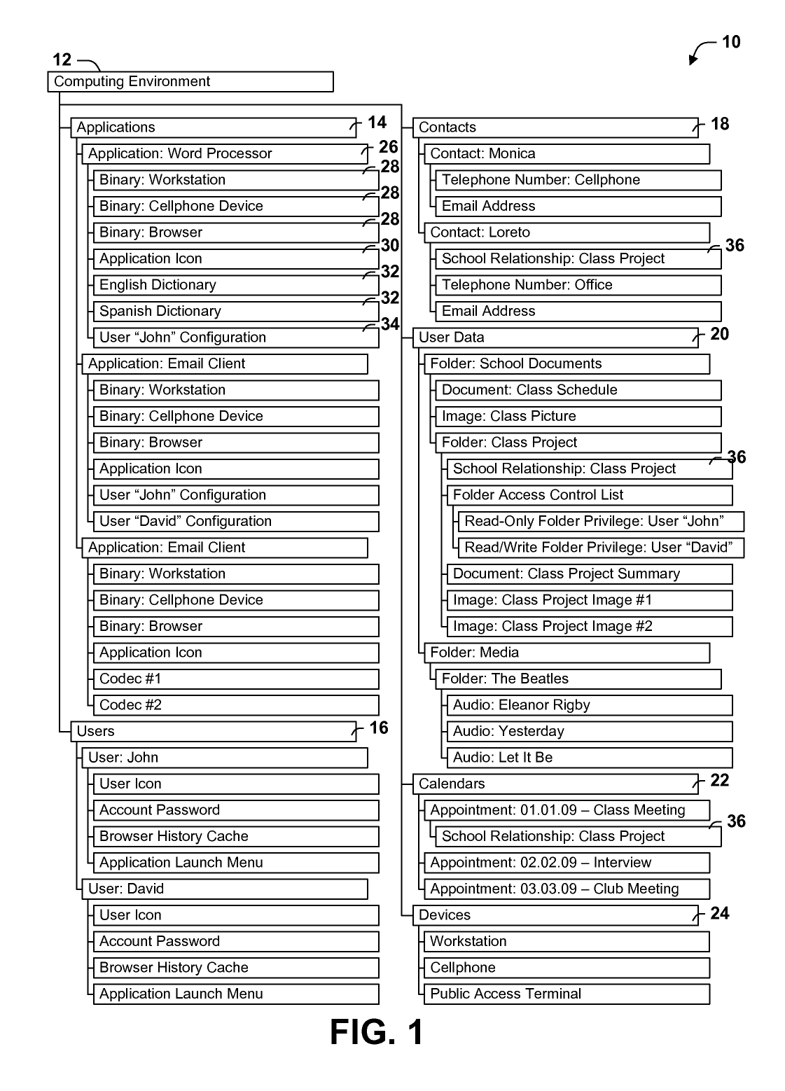

FIG. 1 illustrates a portion of an exemplary object hierarchy 10 that may comprise a computing environment representation such as disclosed herein. The computing environment represented by the illustrated portion of the exemplary object hierarchy 10 comprises applications such as a word processor and an email client, a set of user profiles, a set of user data such as documents and images, contacts, calendar entries, and a set of devices on which the computing environment may be represented and expressed. These objects contain different types of data with different semantic properties, but are organized as objects in a single tree-style hierarchy. Moreover, the object types may be mixed; e.g., the objects comprising an application (such as the word processor application 26) may include some executable binaries 28, an application icon 30, some dictionary sets 32, and configuration information 34 for a particular user. This mixture of object types is more readily achievable in the object hierarchy approach than in other approaches; e.g., in a conventional file system, these components might be distributed, wherein the executable binaries 28 are located in an assembly cache, the application icon 30 and dictionary sets 32 are located in various locations of a file system, and the configuration information 34 is located in a system registry.

The representation of objects comprising a computing environment as an object hierarchy, such as illustrated in FIG. 1, presents many advantages. As a first example, the hierarchy enables each object to be singly located, and to be operated upon in a similar manner as the other objects within the computing environment. As a second example, any device that has access to the object hierarchy may render a similarly presented and configured computing environment containing the same data organized in the same manner. As a third example, a service may be devised that operates on any or all of the objects comprising the computer system in a similar manner. For instance, an object synchronization service may be used to synchronize two object hierarchies (such as between the object hierarchy stored on an object hierarchy server, and a device on which the object hierarchy has been loaded and later altered.) The synchronization may therefore unify all of the objects represented in the two object hierarchies—not just files and similar data objects, but also changes to applications, user profiles, and security tokens. Thus, a set of user profiles may be shared between two devices just as easily and through the same mechanism as a set of documents in a file store. As a fourth example, the objects of the computing environment may be extended by users with any arbitrary data by adding objects to the object set. For instance, several objects of the exemplary object hierarchy 10 of FIG. 1 relate to a class project under development by the users of the computer system. The users may therefore associate these objects with a “school relationship” object 36, which may be stored in the exemplary object hierarchy 10 subordinate to the school project objects. A subsequent query of the computing environment may reveal the locations of the “school relationship” objects 36 and the objects that contain them, thereby relating a contact in the contacts set 18, a folder in the user data set 20, and an appointment in the calendar set 22. The extensibility of the object set represented by the object hierarchy may therefore permit the user to devise and apply new qualities to the computing environment represented thereby.

Some of the advantages that may be realized by a computing environment representation of this nature are related to the representation of the objects in a standard manner, such that the objects may be represented together in the object hierarchy. However, if the objects are represented according to an object format with certain structural constraints, it may be difficult to represent certain kinds of objects according to the object format. For instance, an object format may devised wherein each object has a string specifying its name. However, some objects may be anonymous, and other objects may comprise a plurality of names that cannot be summarized as a single string. However, if the objects share no commonality, then they may only be represented in a plain binary format, such as in a typical file system. Moreover, the representation of objects in this manner may be difficult to serialize for communication. For instance, each object may be coded with a binary-to-text encoding mechanism, such as uuencode, but the resulting objects may be inefficiently large and difficult to manipulate except as raw binary objects. Alternatively, the objects may be represented according to a well-typed system, such as a typical object-oriented programming platform. However, this approach limits the extensibility of the object hierarchy, because custom objects can only be stored if defined according to the typing system, and such definitions may be unavailable.

An alternative approach for representing the objects in a common but content-agnostic manner involves the use of a simple grammar, wherein the components of an object may be represented in a basic manner. For instance, it may be recognized that objects typically contain three types of data elements: atoms (single units of data, such as a number or a character), records (collections of single units of data operating together), and sequences (aggregations of elements.) A record generally denotes a set of elements that function together indivisibly as a representation, such as the numbers 7, 4, and 1776 together representing the date Jul. 4, 1776; whereas a sequence denotes a divisible set of items, such as 2, 3, 5, and 7 comprising a subset of the prime numbers. Moreover, the grammar may be devised with recursion, which may permit the nesting of certain kinds of elements (e.g., sequences of sequences, or a record containing a sequence as one element of the record.)

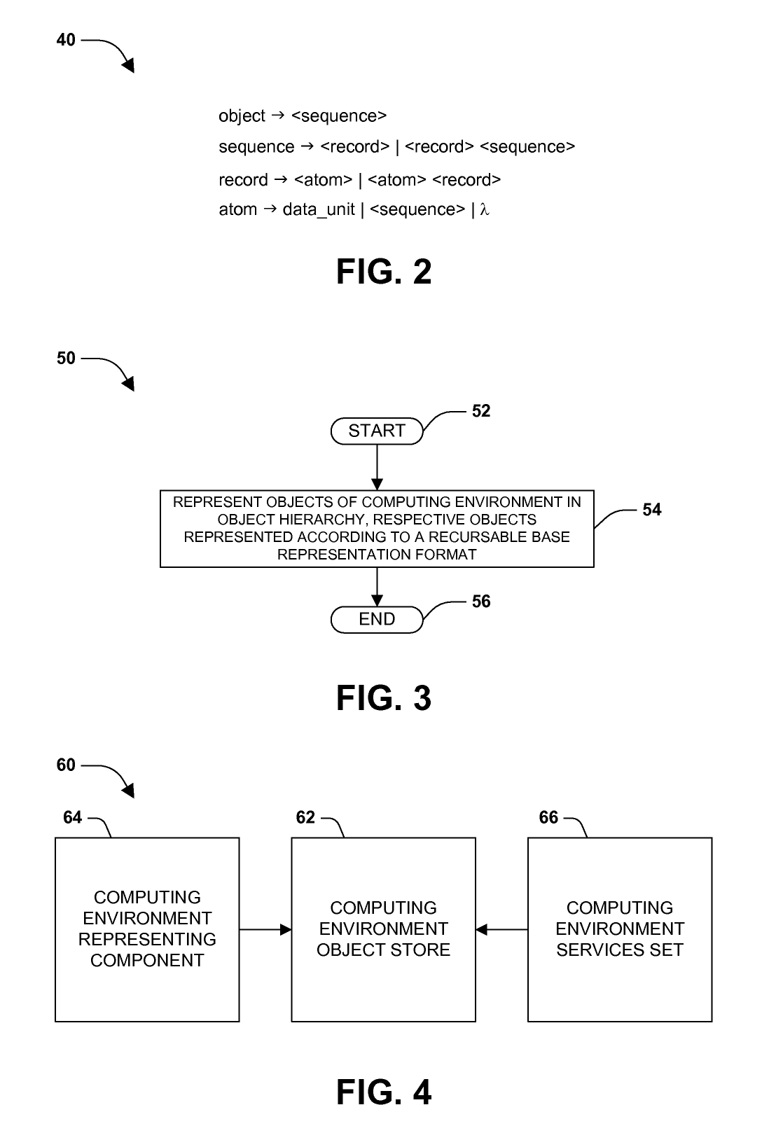

FIG. 2 illustrates an exemplary grammar 40 that specifies that objects are to be represented as sequences of records of atoms. The exemplary grammar 40 permits recursion, such that, instead of specifying an atom, the object may specify another sequence of records of atoms, such that sequences may contain sub-sequences, as may often occur in deeply structured objects. A grammar of this nature is therefore directed toward the organization of data units comprising an object, and does not specify or constrain the types of data items represented therein. The grammar may therefore define a recursable base representation format, wherein objects represented in this manner may be stored in a content-agnostic manner, but with some commonalities that improve the unification of the objects in the object hierarchy according to a simple but common structure.

A first significant advantage of this grammatic representation of the objects comprising the object hierarchy relates to the content-agnostic nature of the organization. Whereas many conventional computer systems are organized as data silos containing similar types of object (e.g., a system registry containing registry entries, an assembly cache containing executable binaries, a file system containing files, and a browser history cache containing browser history cache records), the object hierarchy represented by the exemplary grammar 40 of FIG. 2 is not so constrained. Accordingly, objects may be grouped according to the semantic choices of the user, rather than by the arbitrary technical organization of the system architecture. For instance, an application in a conventional system might be organized as an executable binary accessed through an assembly cache, some supplementary program files accessed through a file system, and user configuration information accessed through a system registry. However, as illustrated in the exemplary object hierarchy 10 of FIG. 1, these diverse types of objects may be stored and represented together in the object hierarchy. The artificial partitioning of the computing environment according to the types of objects may therefore be reduced.

A second significant advantage of this grammatic representation of the objects comprising the object hierarchy relates to the extensibility of the computing environment representation. In many scenarios, a user may wish to add customized data and objects to the object hierarchy, and may wish to extend the information associated with one or more objects, such as through user-defined metadata. As a first example, completely new types of objects may be devised by various users and inserted into the object hierarchy. As long as the objects are represented according to the recursable base representation format (e.g., the recursable sequence/record/atom organization embodied in the exemplary grammar 40 of FIG. 2), the objects may be stored in the object hierarchy, even without specifying a more detailed, content-specific schema to which such objects are intended to conform. Moreover, the services applied to the object hierarchy, such as backup and synchronization services, will be natively compatible and ready to manage the new, custom-defined objects in the same manner as the other objects. As a second example, a user may wish to associate metadata with objects in order to indicate objects having a semantic relationship. FIG. 1 illustrates one such scenario, wherein several objects of various types are associated with a class project, and this relationship may be represented by formulating a custom object (a “school relationship” object 36) and inserting the object into the object hierarchy as a subordinate node of each related object. Such metadata supplements the objects of the object hierarchy with information of value to the user, and does not interfere with the representation of the objects or the services applied thereto.

FIG. 3 illustrates one embodiment of the techniques and approaches discussed above, devised as an exemplary method 50 of representing a computing environment. The exemplary method 50 begins at 52 and involves representing 54 objects of the computing environment in an object hierarchy, where respective objects are represented according to a recursable base representation format (such as the exemplary grammar 40 of FIG. 2.) Having achieved the representation of the computing environment as a set of objects structured according to a recursable base representation format and positioned in an object hierarchy, the exemplary method 50 achieves the representation of the computing environment according to the techniques discussed herein, and so ends at 56.

FIG. 4 illustrates another embodiment of the techniques and approaches discussed above, devised as an exemplary system 60 for representing a computing environment. The exemplary system 60 comprises a computing environment object store 62, which is configured to store objects comprising the computing environment. The exemplary system 60 also comprises a computing environment representing component 64, which is configured to represent the objects of the computing environment in an object hierarchy, wherein respective objects are represented according to a recursable base representation format (such as the exemplary grammar 40 of FIG. 2.) The exemplary system 60 also comprises a computing environment services set 66, which in turn comprises at least one computing environment service configured to operate on the objects of the computing environment. The components configured in this manner therefore produce an exemplary system 60 for representing a computing environment in accordance with the techniques discussed herein.

The representation of the computing environment as described herein may vary in several aspects, and some variations may present additional advantages and/or mitigate disadvantages with respect to other variations of these and other techniques. Such variations may be incorporated, alone or in combination, in many embodiments of these techniques, such as the exemplary method 50 of FIG. 3 and the exemplary system 60 of FIG. 4.

A first aspect that may vary among implementations of these techniques relates to the structural representation of the objects according to the recursable base representation format. As noted in the description of the exemplary grammar 40 of FIG. 2, the objects may be represented according to the structure of data units comprising the object, e.g., as a recursable sequence of records of atoms. This structural representation permits a content-agnostic organization of the data units comprising the object without involving a specification of the nature (e.g., the types, names, and validation) of the data units. This structural representation is also advantageous for providing an easy transformation of such objects into any representation format, such as any variety of XML, JSON, YAML, binary or textual serialization, etc. However, other recursable base representation formats may be devised, some of which may provide more coherent structure such as some defined primitive types (but possibly at the expense of the variety of objects that may be represented thereby), and some of which may provide greater flexibility (but possibly at the expense of the representative commonality of objects upon which services may operate.) Those of ordinary skill in the art may devise many recursable base representation formats in which objects may be represented within a computing environment in accordance with the techniques discussed herein.

A second aspect that may vary among implementations of these techniques relates to the organization of the object hierarchy. As one example, and as illustrated in the exemplary object hierarchy 10 of FIG. 1, the structural formatting of the objects may comprise a conventional tree structure, comprising a root node containing other nodes that may contain still other nodes, etc. This model of object hierarchy organization constrains each object to a single location in the object hierarchy, which may be advantageous in consistently identifying objects (e.g., two objects located at different positions in the object hierarchy may be presumed to comprise two different objects) and in enumerating the objects of the object hierarchy by recursively traversing the nodes of the tree structure. This model of object hierarchy organization may also reflect a similarity with well-known representation formats, such as XML and JSON, and may enable an easy translation of the object hierarchy to such representation formats (again, regardless of the nature of the objects organized therein.) However, other models of object hierarchy organization may be compatible with the techniques discussed herein, and may be desirable in certain aspects. As a first example, an object hierarchy may be organized as a directed acyclic graph, such that an object positioned as a node in the graph may have more than two parent nodes in the graph. This organization may diminish some advantages of a tree structure (e.g., an object may be identified by a plurality of hierarchical paths through the graph, so two objects located at different positions in the object hierarchy may not be presumed to comprise two different objects.) However, this organization may permit an object to be present in multiple locations, which may be advantageous for some collections of objects, and which may avoid the redundant storage of a single object in multiple locations. As a second example, an object hierarch may be organized as a partially undirected graph, such as a tree structure where two nodes of the same order may be fraternally related. For instance, in the exemplary object hierarchy 10 of FIG. 1, objects organized under a single node may be related to form an object group; e.g., some of the audio objects stored in the media folder entitled “The Beatles” may be relationally linked to signify an album. Many models of object hierarchy organization may be devised by those of ordinary skill in the art and utilized in embodiments of the techniques discussed herein.

A third aspect that may vary among implementations of these techniques relates to different ways of expressing the computing environment representation. The computing environment representation may often be expressed as a complete set of objects comprising the entire object hierarchy of the computing environment. However, the expression may adjusted, such as by adding or removing detail, rearranging or omitting portions of the object hierarchy, and transforming the representation into representation formats other than the recursable base representation format.

A first example of a transformation of the computing environment representation relates to the amount of detail provided in a representation of the computing environment. A system may be configured to store all of the objects of the object hierarchy comprising the computing environment (such as within the computing environment object store 62 of the exemplary system 60 of FIG. 4), but, in certain circumstances, may represent only a portion of the object hierarchy and only a subset of the objects organized therein.

Many scenarios may motivate such a partial representation. As a first scenario, it may be appreciated that the large number, sizes, and varieties of objects comprising a computing environment may involve a considerable amount of storage space. Many devices may not be have sufficient capacity to store the complete representation, such as a cellphone device featuring a limited amount of solid-state storage. Accordingly, where the computing environment represented to a device, the representation may be adjusted according to capabilities of the device.

As a second scenario, a device requesting the computing environment may simply not need some objects in the object hierarchy, which may be omitted for convenience. For instance, a representation of the exemplary object hierarchy 10 of FIG. 1 on behalf of a cellphone device may omit the application binaries that are configured for other types of devices, such as the workstation binaries and browser binaries.

As a third scenario, a device may be in communication with the system storing the complete representation over a communications channel of limited bandwidth. Indeed, even comparatively fast network connections may be unable to transmit a complete representation of the computing environment in a timely manner. For instance, transmitting a 100 gigabyte computing environment representation over an 802.11 g wireless connection capable of a theoretical maximum of 6.75 megabytes/second transfer rate (not accounting for network overhead) may entail over four hours of dedicated, completely saturated bandwidth.

As a fourth scenario, the computing environment may be represented on behalf of an untrusted user (such as a visitor, or a user having only limited access to the computing environment) or on an untrusted device (such as a public terminal.) It may be desirable to restrict access to certain objects or portions of the object hierarchy. Thus, portions of the object hierarchy may be identified as withheld due to inadequate authorization, or may be obfuscated such that the withholding is undetectable, and the objects and the omitted portion of the object hierarchy are simply not visible. Accordingly, the representation adjusted according to the user.

As a fifth scenario, a portion of the object hierarchy may not be stored by the system hosting the computing environment representation, but may be stored elsewhere. For instance, some of the objects comprising the object hierarchy may be stored on various devices, and may be retrieved from the device and included in the representation (when the device storing such objects is reachable and communicable.) For instance, a computing environment may be represented as an object hierarchy including a set of contacts (e.g., the contacts set 18 of the exemplary object hierarchy 10 of FIG. 1) stored on a cellphone device. The objects may (or may not) be retrievable, but before a request for retrieval is made, the computing environment representation may omit these objects and these nodes of the object hierarchy, and may reference the object store on which the objects are located and may be retrieved upon request.

In these and other scenarios, the computing environment may be represented in a partitioned manner, comprising only a portion of the object hierarchy and a subset of the objects organized therein. One manner of achieving this partitioning is by representing one or more nodes of the object hierarchy as an unexpanded node, with the object of the node and the subordinate (child) nodes of the node omitted. The unexpanded node may be indicated as such in the representation. As a first example, where the computing environment is represented on behalf of a device having a capability such as a device storage capacity, the computing environment may be represented with at least one representing the computing environment with unexpanded nodes to limit the size of the represented computing environment to not exceed the device storage capacity. As a second example, where the computing environment is represented on behalf of a user, the computing environment may specify a user account for the user, and the computing environment specifying the access privileges for the user account to the objects of the computing environment. In this case, the computing environment representation may be adjusted by representing the computing environment with at least one unexpanded node representing a portion of the object hierarchy restricted from the user according to the access privileges of the user account.

Moreover, the unexpanded node may be indicated as available upon request, and the system hosting the complete representation of the computing environment may be configured to receive and process requests to expand unexpanded nodes. For instance, the exemplary system 60 of FIG. 4 may be configured, upon receiving a request to expand an unexpanded node, to provide the object of the unexpanded node. The system may also expand the node by representing the subordinate nodes of the object hierarchy. Alternatively, the system may respond to such a request by expanding the node but by representing some of the subordinate (child) nodes of the node as unexpanded nodes, which may be subsequently requested for expansion. As a second alternative, the system may decline to expand the node, e.g., if the node was represented in an unexpanded manner due to restricted access to the unexpanded portion of the object hierarchy. As a third alternative, where the unexpanded node references an object store (e.g., another device) on which the objects are stored, a request may be issued to the object store for the objects of the unexpanded node; if the object store can be reached and provides the omitted objects, then upon receiving the object(s) from the data store, the objects may be provided in response to the request to supplement the object hierarchy and expand the unexpanded node.

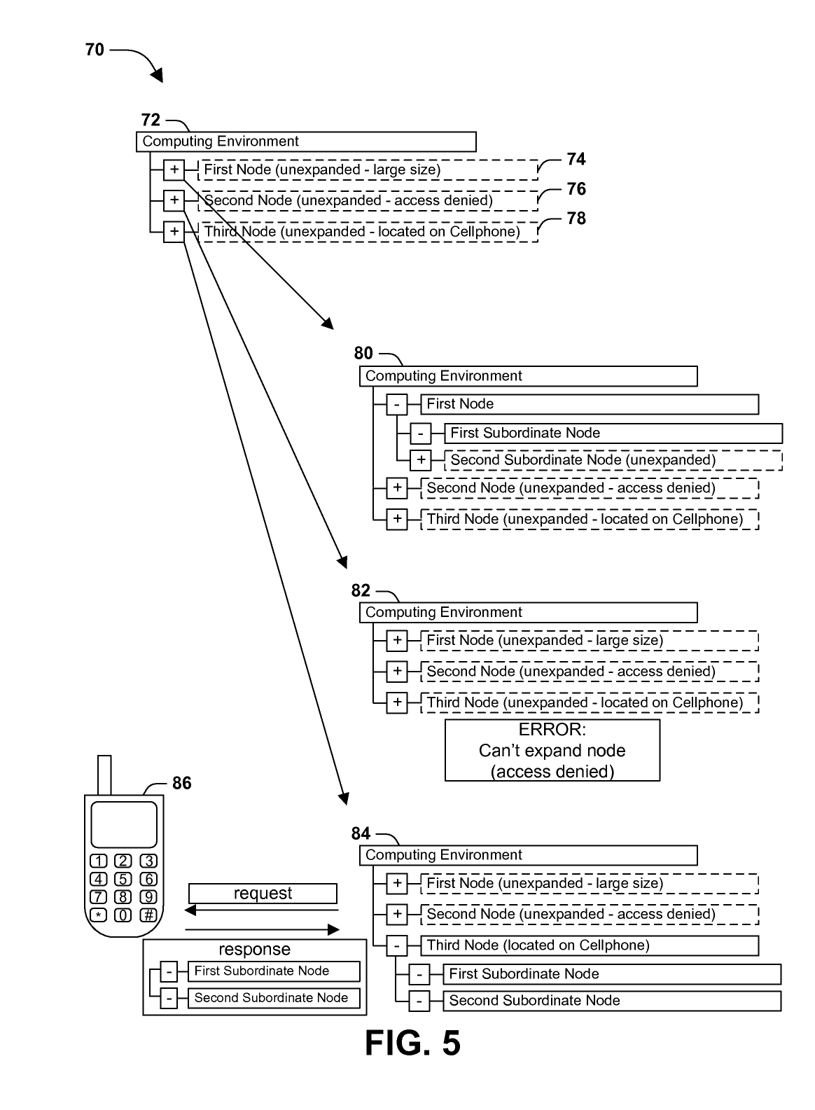

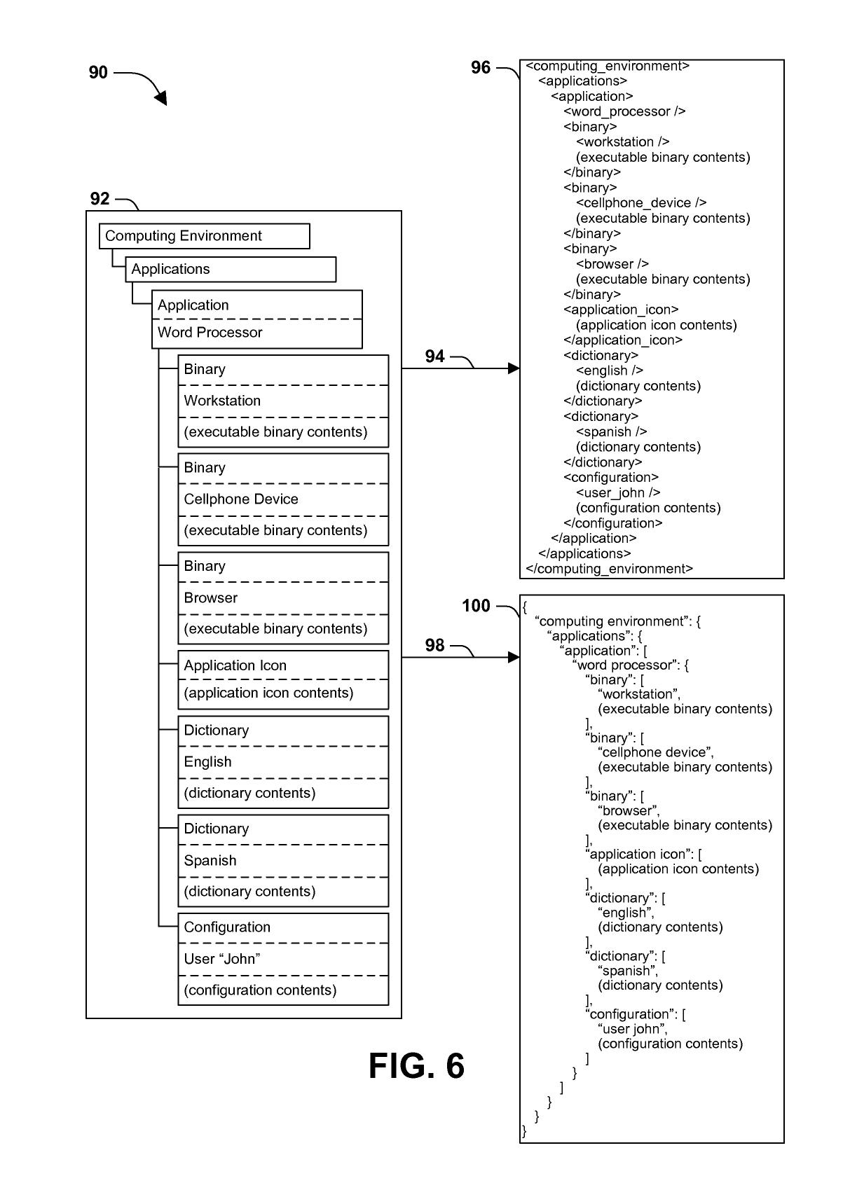

FIG. 5 illustrates an example 70 of a first exemplary computing environment representation 72 having three unexpanded nodes: a first unexpanded node 74 omitted due to size considerations, a second unexpanded node 76 omitted due to insufficient access privileges, and a third unexpanded node 78 omitted due to the distributed storage of the object and its subordinate nodes on a device included in the computing environment (in this scenario, a cellphone device.) In the first object representation 72, the unexpanded nodes are indicated as unexpanded, and may be requested for expansion. The second exemplary computing environment representation 80 illustrates the result of requesting an expansion of the first unexpanded node 74, resulting in a more fully represented computing environment. However, some subordinate nodes of the first unexpanded node 74 are still represented as unexpanded nodes (for unspecified reasons), and may be subsequently requested for expansion. The third exemplary computing environment representation 82 illustrates the result of requesting an expansion of the second unexpanded node 76, wherein the expansion is denied due to insufficient access privileges. The system hosting the computing environment may (as illustrated in FIG. 5) return an error indicator, such as an exception, may simply decline to expand the node, and/or may represent the node as being empty and devoid of subordinate nodes. The fourth exemplary computing environment representation 84 illustrates the result of requesting an expansion of the third unexpanded node 78, resulting in a request issued to the object store hosting the third unexpanded node 78 (i.e., the cellphone device) and a supplementing of the computing environment representation with the object so returned. The request could be made by the system hosting the computing environment representation, or by the device requesting the expansion of the third unexpanded node 78. The latter request may be backed by an indication of permission granted by the system hosting the computing environment representation, and/or an authentication of the request that securely identifies the requesting device or user as an assertion of security clearance, and the device hosting the third unexpanded node 78 may examine and verify such security credentials before providing the object of the third unexpanded node 78. Those of ordinary skill in the art may be able to devise many scenarios for representing unexpanded nodes in the object hierarchy, and many techniques for receiving, processing, and responding to requests for expansion of unexpanded nodes, while implementing the techniques discussed herein.

A second example of an adjustment of the computing environment representation relates to the expression of the representation according to a data interchange format. Many protocols have been and may be devised for expressing objects in an object hierarchy, such as XML, JSON, YAML, binary serialization, and textual serialization. These and other data interchange formats offer various advantages and disadvantages, such as extensibility, ease of schema transformation, compactness, supplementation with various services (e.g., XPath querying and XSL transformations), intercompatibility with other data interchange formats (e.g., XHTML), and degrees of support in various languages (e.g., Python and Perl.) Moreover, most data interchange formats are capable of representing nested objects organized according to the minimal principles of a recursive base representation format (e.g., the representation of data units organized as atoms, records, and sequences.)

FIG. 6 illustrates two such transformations from a recursive base representation format to two data interchange formats: XML and JSON. The example 90 of FIG. 6 begins with a portion of an exemplary object hierarchy 92 comprising the data items for a word processor application, including application binaries, application icons, dictionaries, and a configuration file for a particular user. In contrast with the exemplary object hierarchy 10 of FIG. 1, this representation is illustrated according to a sequence/record/atom recursive base representation format, wherein atoms are represented as boxes, records are represented as aggregations of atoms (divided by a phantom line), and sequences are represented as subordinate nodes of a sequence-encapsulating element in the tree representation of the object hierarchy. Because of the sequence/record/atom organization of the elements of the exemplary object hierarchy 92, transformations may be applied to denote the same organizational concepts in various data interchange formats. A first transformation may be applied to format the exemplary object hierarchy 92 as an XML representation 94, wherein a record is represented as an enclosing element (<record> and </record>) encapsulating the atoms of the record as empty nodes (<atom/>), and a sequence is represented as an enclosing element (<sequence> and </sequence> encapsulating the elements of the sequence (<binary> . . . , <binary> . . . , <dictionary> . . . , etc.) Similarly, a second transformation may be applied to format the exemplary object hierarchy 92 as a JSON representation 96, according to the JSON conventions of representing a record with square brackets (“binary”: [ . . . ]) and a sequence with curly braces (“applications”: { . . . }). Other transformations may be developed to automate the transformation of an object hierarchy from the recursive base representation format to another data interchange format without loss of information or complexities with respect to the contents of the object hierarchy. Those of ordinary skill in the art may devise many techniques for transforming the recursive base representation format to other formats while implementing the techniques discussed herein.

A third example of an adjustment of the computing environment representation relates to the production of class instances structured according to a platform representation, where such class instances are represented in the object hierarchy. Many computing platforms support the definition of classes, which may specify various member items, methods, events, interfaces, and security/access details with respect to members of the class. A computing environment configured to operate on these platforms may encapsulate instances of such classes in the represented object hierarchy, and it may be desirable to generate class instances from the object hierarchy. For instance, the exemplary object hierarchy 10 of FIG. 1 includes a contacts set, and a computing platform may define a class for a contact comprising fields for the contact's name, email address, and various telephone numbers. The exemplary object hierarchy 10 may therefore be rendered as two class instances of the Contact class: one for the contact named Monica, and one for the contact named Loreto. Accordingly, an embodiment of these techniques (such as the exemplary method 50 of FIG. 3, or the exemplary system 60 of FIG. 4) may include a marshaling of the objects of the computing environment as instances of the at least one class of a platform representation format. This marshalling may be performed by the host of the computing environment representation, but such class instances are then to be serialized for delivery across a communication channel to the device comprising the platform representation. Alternatively, the marshalling may be performed on the device hosting the platform wherein the classes are defined; this may present an advantage by permitting the host of the computing environment to deliver the computing environment representation in a platform-agnostic manner, and to delegate the marshalling of class instances to the device hosting the platform. Those of ordinary skill in the art may be able to devise many uses of class instance marshalling with respect to the techniques discussed herein.

A fourth aspect that may vary among implementations of these techniques relates to the alteration of the representation. In many cases, a session of a computing environment on a device may result in an alteration of the computing environment, such as a creation of objects or new portions of the object hierarchy, an updating of an object or a portion of the object hierarchy, or a deletion of an object or a portion of the object hierarchy. Indeed, a large number of alterations to the computing environment may be made even during a short session of ordinary use where the computing environment includes commonly used caches, such as browser histories and most-recently-used item lists. The alterations may be stored locally in the device, but until the alterations are propagated to the host of the computing environment representation, the alterations may not be visible to other devices (except, e.g., where the altered portion of the object hierarchy is delegated to storage in the object store of the device.)

Accordingly, embodiments of these techniques may be capable of receiving and applying alterations to the computing environment representation. For instance, a system configured to store the representation of the computing environment (such as the exemplary system 60 of FIG. 4) may include a computing environment altering component configured to receive at least one computing environment alteration, and to alter the object hierarchy according to the computing environment alteration. As a first example, where the alteration specifies the deletion of objects (e.g., files) represented in the computing environment, the device upon which the deletion was performed may notify the system hosting the representation of the computing environment with respect to the deletion, and the system may remove the deleted objects from the object hierarchy. As a second example, a device hosting a platform may be operated to create new class instances based on the classes defined by the platform (e.g., the creation of a new Contact class instance based on a Contacts class.) The device may serialize the new class instance and deliver it to the system hosting the representation of the computing environment, which may insert new objects into the object hierarchy corresponding to the data comprising the class instance. In this example, it may be advantageous to transform the class instance into an object representation according to the recursable base representation format, in conformity with the representation of other objects in the object hierarchy. This transformation may be performed on the device, or on the system hosting the representation of the computing environment, etc. Those of ordinary skill in the art may be able to devise many ways of altering the object hierarchy to reflect changes in the computing environment while implementing the techniques discussed herein.

A fifth aspect that may vary among implementations of these techniques relates to the services that may be applied to the objects and the object hierarchy comprising the computing environment. The variety of objects included in the computing environment representation may span a considerable gamut of variety, including data files such as images, user profile information, passwords, application binaries, and various data caches. However, because the objects of the object environment are stored according to a recursable base representation format, a set of services may be applied to manipulate the objects of the computing environment in a similar manner. For example, a synchronization service may be devised to synchronize a portion or entirety of one object hierarchy (such as the object hierarchy stored by the server responsible for hosting the computing environment) with a portion or entirety of another object hierarchy (such as the object hierarchy stored on a device and altered during a session of the computing environment operated thereupon.) The synchronization may be performed in many ways, such as unidirectionally (making one object hierarchy match another), bidirectionally based on the date of the updates, bidirectionally based on user choices, etc. A backup service may be devised to generate and store a full or differential image of an object hierarchy on an archival device, such as a tape drive. A querying service may be devised to identify objects in the object hierarchy matching a certain description (e.g., locating all of the objects in the exemplary object hierarchy 10 of FIG. 1 containing a “school relationship” object 36, and thereby represented as related to the class project; this query results in an identification of the “Loreto” contact object, the “Class project” folder object, and the Jan. 1, 2009 class meeting appointment object.) A sharing service may be devised to extend various types of access to various portions of the object hierarchy to various types of users and devices; e.g., some of the objects may be publicly shared with read-only access to any guest user operating any sort of device, while some other objects may be accessible with read/write access by an authenticated set of users operating an authenticated set of devices. An object event reporting service may be devised to log and report alterations to a portion or entirety of the object hierarchy, e.g., new, changed, and deleted files stored in a particular folder.

Because these services operate on the objects represented according to the recursable base representation format, the services may be configured to apply to very different types of objects in a uniform manner; e.g., synchronizing a user profile among various devices through a synchronization service may be performed in the same manner as synchronizing files among various file stores. Accordingly, embodiments of these techniques (such as the exemplary method 50 of FIG. 3 and the exemplary system 60 of FIG. 4) may include a computing environment services set, which may comprise at least one of an object backup service, an object query service, an object synchronization service, and an object event reporting service. These services may be provided on the system hosting the representation of the computing environment, and may be configured (automatically and/or manually) to apply various operations to the object hierarchy in the interests of maintenance, security, end-user service provision, etc.

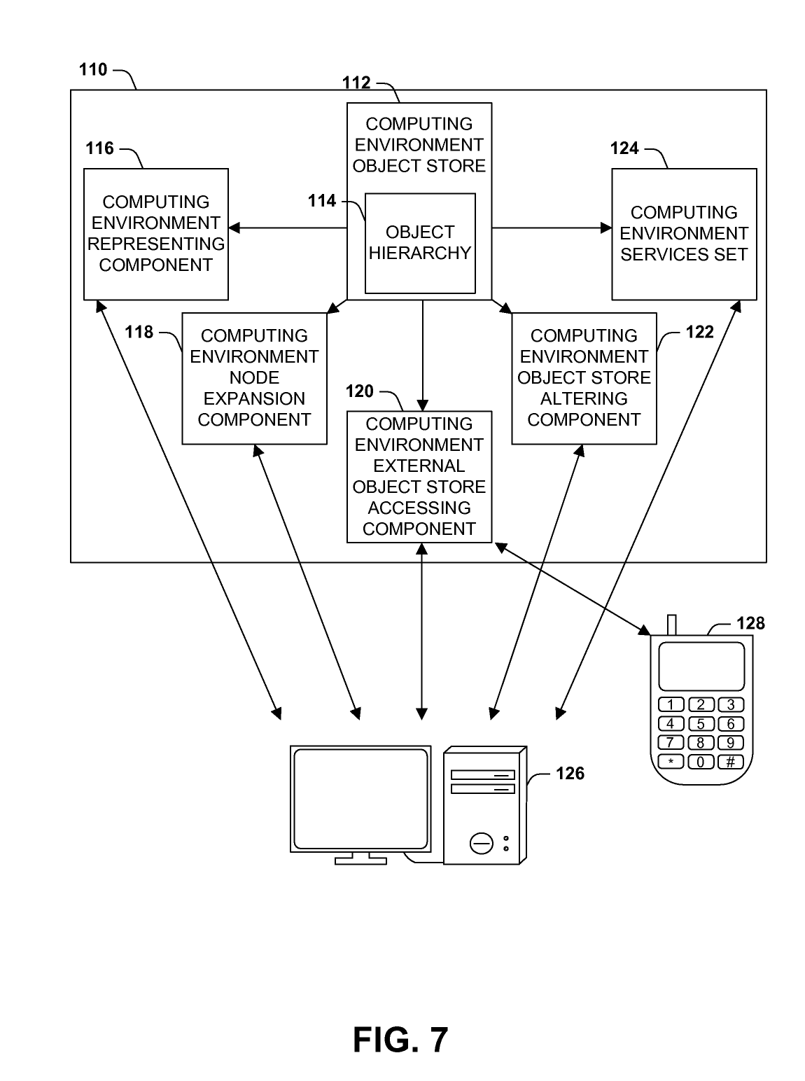

The variations of the aspects discussed hereinabove may also be implemented in combination to provide several of the advantages and to reduce several of the disadvantages discussed heretofore. One such combination is illustrated in FIG. 7, illustrating an exemplary system 110 for representing a computing environment. The exemplary system 110 comprises a computing environment object store 112 configured to store an object hierarchy 114 of objects comprising the computing environment, wherein respective objects are represented according to a recursable base representation format comprising a recursable sequence of records of atoms. The objects comprising the object hierarchy 114 may be accessed by various components of the exemplary system 110, such as a workstation 126, to render and interact with the computing environment represented by the exemplary system 110.

To facilitate such accessing, a system of this nature (such as the exemplary system 110 of FIG. 7) comprises a computing environment representing component 116 configured to receive a request (e.g., from the workstation 126) for the computing environment specifying a data interchange format, to transform the object hierarchy 114 from the recursable base representation format into the data interchange format, and to provide the transformed object hierarchy in response to the request. The exemplary system 110 also comprises a computing environment node expansion component 118, which is configured, upon receiving a request to expand an unexpanded node representing an object of the object hierarchy 114, to provide the object. The exemplary system 110 also includes a computing environment external object store accessing component 120, which is configured, upon receiving a request to expand an unexpanded node representing an object of the object hierarchy 114 and referencing an external object store (such as a cellphone device 128), to request the object from the external object store 128, and upon receiving the object from the external object store 128, provide the object in response to the request. The exemplary system 110 also comprises a computing environment altering component 122 configured to receive at least one computing environment alteration, to transform objects represented in the computing environment alteration into an object representation according to the recursable base representation format, and to alter the object hierarchy according to the computing environment alteration. The exemplary system 110 also comprises a computing environment services set 124, comprising at least one computing environment service configured to operate on the objects of the computing environment (e.g., an object query service, an object mirroring service, and an object synchronization service.) Systems configured in this manner may therefore provide a deployable, consistent, and extensible computing environment representation to a variety of devices. However, those of ordinary skill in the art may be able to devise many such systems while implementing the techniques discussed herein.

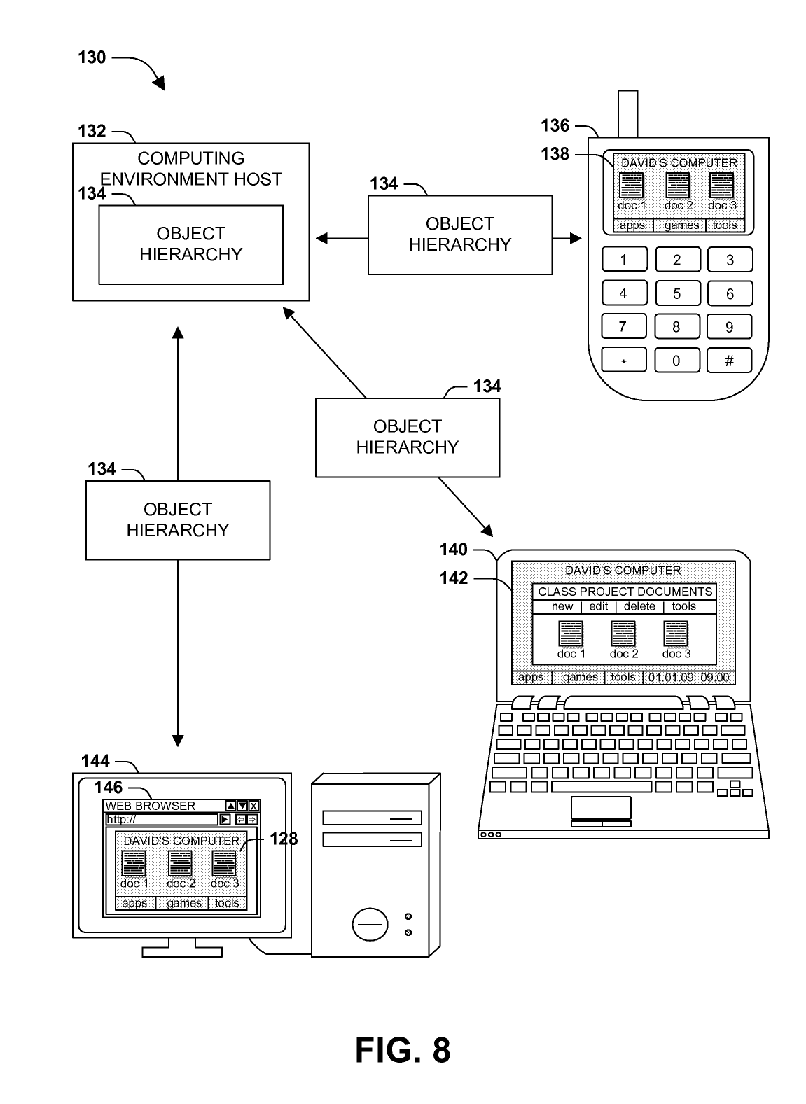

In view of the foregoing techniques and variations, it may be appreciated that this formulation and management of an object hierarchy enables a deployable computing environment operating in a consistent manner on a variety of devices. FIG. 8 illustrates one such scenario 130, wherein the computing environment may be hosted by a computing environment host 132, which may store and manage an object hierarchy 134. The computing environment host 132 may also render the object hierarchy 134 in different ways on behalf of various devices, such as a cellphone device 136, a personal notebook computer 140, and a public workstation 144, and also on behalf of different types of users having different access privileges. The rendering of the computing environment therefore reflects a consistent computing environment across all devices that expose the same applications, user profiles, shell configuration, user data objects, etc. Thus, a user may access a full-featured version 142 of the computing environment through a high-performance notebook computer, a stripped-down version 138 of the computing environment on a low-power cellphone device 136, and a browser-compatible and privacy-oriented version 148 of the computing environment through a web browser 146 of a public terminal 144. To the extent that the capabilities of each such device support the rendering of the computing environment, a consistent user interface and data set may be presented due to the rendering of the object hierarchy 134 adjusted to the capabilities of each device. Updates to the computing environment may be propagated back to the computing environment host 132, and may be automatically synchronized with other devices. The various devices may also cooperate by sharing locally stored data with other devices, and by controlling or being controlled by other devices. Hence, the computing environment may therefore be devised and presented as a cloud computing architecture, comprising a device-independent representation (a “cloud”) expressed as a consistent rendering across all devices (“clients”) that form a mesh of cooperating portals (with device-specific properties) to the same computing environment. Moreover, the computing environment host 132 may apply services to the various objects comprising the object hierarchy 134, and the object-based hierarchical organization and recursable base representation format may facilitate consistent availability and application of the services regardless of the nature of the objects applied thereto. Those of ordinary skill in the art may appreciate several advantages and reduced disadvantages provided by this cloud computing architecture when compared with mainframe, desktop ad hoc, client/server, and thin-client architectures.

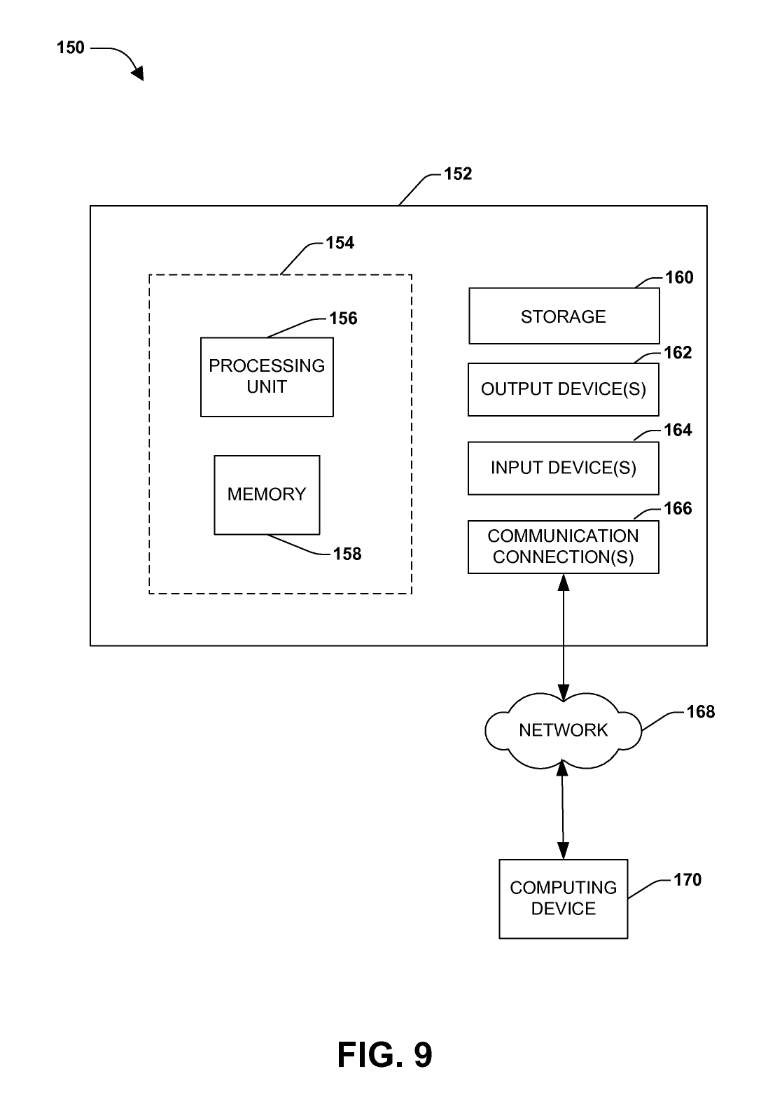

FIG. 9 and the following discussion provide a brief, general description of a suitable computing environment to implement embodiments of one or more of the devices set forth herein, such as the computing environment host 132 of FIG. 8 or a device configured to render the computing environment, such as a personal notebook computer 140. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 150 comprising a computing device 152 configured to implement one or more embodiments provided herein. In one configuration, computing device 152 includes at least one processing unit 156 and memory 158. Depending on the exact configuration and type of computing device, memory 158 may be volatile (such as RAM, for example), non-volatile (such as ROM, flash memory, etc., for example) or some combination of the two. This configuration is illustrated in FIG. 9 by dashed line 154.

In other embodiments, device 152 may include additional features and/or functionality. For example, device 152 may also include additional storage (e.g., removable and/or non-removable) including, but not limited to, magnetic storage, optical storage, and the like. Such additional storage is illustrated in FIG. 9 by storage 160. In one embodiment, computer readable instructions to implement one or more embodiments provided herein may be in storage 160. Storage 160 may also store other computer readable instructions to implement an operating system, an application program, and the like. Computer readable instructions may be loaded in memory 158 for execution by processing unit 156, for example.

The term “computer readable media” as used herein includes computer storage media. Computer storage media includes volatile and nonvolatile, removable and non-removable media implemented in any method or technology for storage of information such as computer readable instructions or other data. Memory 158 and storage 160 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 152. Any such computer storage media may be part of device 152.

Device 152 may also include communication connection(s) 166 that allows device 152 to communicate with other devices. Communication connection(s) 166 may include, but is not limited to, a modem, a Network Interface Card (NIC), an integrated network interface, a radio frequency transmitter/receiver, an infrared port, a USB connection, or other interfaces for connecting computing device 152 to other computing devices. Communication connection(s) 166 may include a wired connection or a wireless connection. Communication connection(s) 166 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 152 may include input device(s) 164 such as keyboard, mouse, pen, voice input device, touch input device, infrared cameras, video input devices, and/or any other input device. Output device(s) 162 such as one or more displays, speakers, printers, and/or any other output device may also be included in device 152. Input device(s) 164 and output device(s) 162 may be connected to device 152 via a wired connection, wireless connection, or any combination thereof. In one embodiment, an input device or an output device from another computing device may be used as input device(s) 164 or output device(s) 162 for computing device 152.

Components of computing device 152 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 152 may be interconnected by a network. For example, memory 158 may be comprised of multiple physical memory units located in different physical locations interconnected by a network.

Those skilled in the art will realize that storage devices utilized to store computer readable instructions may be distributed across a network. For example, a computing device 170 accessible via network 168 may store computer readable instructions to implement one or more embodiments provided herein. Computing device 152 may access computing device 170 and download a part or all of the computer readable instructions for execution. Alternatively, computing device 152 may download pieces of the computer readable instructions, as needed, or some instructions may be executed at computing device 152 and some at computing device 170.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of representing a computing environment, the method comprising:
representing objects of the computing environment in an object hierarchy, respective objects represented according to a recursable base representation format.

2. The method of claim 1, the recursable base representation format comprising a recursable sequence of records of atoms.

3. The method of claim 1, the object hierarchy represented as XML.

4. The method of claim 1, at least one object represented as an unexpanded node.

5. The method of claim 4, the method comprising:
upon receiving a request to expand an unexpanded node, providing the object of the unexpanded node.

6. The method of claim 1:
the unexpanded node referencing an object store containing the object of the unexpanded node, and
the method comprising: upon receiving a request to expand an unexpanded node referencing an object store:
requesting the object from the object store, and
upon receiving the object from the data store, providing the object in response to the request.

7. The method of claim 1:
the computing environment represented to a device, and
the representation adjusted according to capabilities of the device.

8. The method of claim 7:
the capabilities of the device including a device storage capacity, and
the adjusting comprising: representing the computing environment with at least one unexpanded node to limit the size of the represented computing environment to not exceed the device storage capacity.

9. The method of claim 1:
the computing environment represented for a user, and
the representation adjusted according to the user.

10. The method of claim 9:
the computing environment specifying a user account for the user,
the computing environment specifying the access privileges for the user account to the objects of the computing environment, and
the adjusting comprising: representing the computing environment with at least one unexpanded node representing a portion of the object hierarchy restricted from the user according to the access privileges of the user account.

11. The method of claim 1, comprising:
transforming the computing environment from the recursable base representation format to a data interchange format.

12. The method of claim 1, comprising:
marshaling the objects of the computing environment as instances of at least one class of a platform representation format.

13. A system for representing a computing environment, the system comprising:
a computing environment object store configured to store objects comprising the computing environment;
a computing environment representing component configured to represent the objects of the computing environment in an object hierarchy, respective objects represented according to a recursable base representation format; and
a computing environment services set comprising at least one computing environment service configured to operate on the objects of the computing environment.

14. The system of claim 13:
at least one object of the object hierarchy represented as an unexpanded node, and
the system comprising: a computing environment node expansion component configured, upon receiving a request to expand an unexpanded node, to provide the object of the unexpanded node.

15. The system of claim 14:
at least one unexpanded node referencing an object store containing the object of the unexpanded node, and
the system comprising: a computing environment object store accessing component configured, upon receiving a request to expand the unexpanded node referencing the object store, to:
request the object from the object store, and
upon receiving the object from the data store, provide the object in response to the request.

16. The system of claim 13:
the computing environment representing component configured to:
receive a request for the computing environment specifying a data interchange format, and
transforming the computing environment from the recursable base representation format to the data interchange format.

17. The system of claim 13, comprising:
a computing environment altering component configured to:
receive at least one computing environment alteration, and
altering the object hierarchy according to the computing environment alteration.

18. The system of claim 17:
the computing environment alteration including at least one class instance of the computing environment according to a representation format, and
the computing environment altering component configured to transform the class instance into an object representation according to the recursable base representation format.

19. The system of claim 13, the computing environment services set comprising at least one of an object backup service, an object query service, an object synchronization service, and an object event reporting service.

20. A system for representing a computing environment, the system comprising:
a computing environment object store configured to store an object hierarchy of objects comprising the computing environment, respective objects represented according to a recursable base representation format comprising a recursable sequence of records of atoms;
a computing environment representing component configured to:
receive a request for the computing environment specifying a data interchange format,
transform the object hierarchy from the recursable base representation format into the data interchange format, and
provide the transformed object hierarchy in response to the request;
a computing environment node expansion component configured, upon receiving a request to expand an unexpanded node representing an object of the object hierarchy, to provide the object;
a computing environment external object store accessing component configured, upon receiving a request to expand an unexpanded node representing an object of the object hierarchy and referencing an external object store, to:
request the object from the external object store, and
upon receiving the object from the external object store, provide the object in response to the request;
a computing environment altering component configured to:
receive at least one computing environment alteration,
transform objects represented in the computing environment alteration into an object representation according to the recursable base representation format, and
alter the object hierarchy according to the computing environment alteration; and
a computing environment services set comprising at least one computing environment service configured to operate on the objects of the computing environment.
